(19) United States
(12) Patent Application Publication
(10) Pub. No.: US 2001/0008014 A1
(43) Pub. Date: Jul. 12, 2001

(54) Automatic network connection using a smart card

(76) Inventors: Brendan Farrell, Dublin (IE); Patrick O'Donnell, Cork (IE)

Correspondence Address: JACOBSON, PRICE, HOLMAN & STERN, PROFESSIONAL LIMITED LIABILITY COMPANY, THE JENIFER BUILDING, 400 SEVENTH STREET, N.W., WASHINGTON, DC, 20004, US

(21) Appl. No.: 09/769,351

(22) Filed: Jan. 26, 2001

Related U.S. Application Data
(63) Continuation of application No. PCT/IE99/00077, filed on Jul. 27, 1999.

(30) Foreign Application Priority Data
Jul. 28, 1998 (IE) 980628
Feb. 23, 1999 (IE) 990141

(51) Int. Cl. H04L 9/32; G06F 12/14

(52) U.S. Cl. 713/185; 713/202; 713/189

(57) ABSTRACT

A portable communication device (1) automatically accesses a network server such as an ISP upon insertion of a card (30). The card (30) stores user-specific data setting conditions for controlled access to the server. This allows different users to have controlled access according to their situation. For example a child may use a card for access confined to children's Web sites. The device (1) updates the card and encrypts the user data. Proxy servers are used to control access.

### INTRODUCTION

1. Field of the Invention

The invention relates to communication on networks such as the Internet, intranets or extranets.

2. Prior Art Discussion

At present such communication is performed by computers such as PCs either in the home or the workplace. In many situations, such an arrangement is satisfactory because the computers are needed for various intensive applications other than communication. However, in recent years software for even basic applications such as word processing has become very complex, resulting in a demand for more powerful hardware. This has kept up the cost of computer systems, both for purchase and for maintenance. These factors are restricting the growth of network communication and thus the market for electronic commerce is also restricted.

Another factor which has restricted growth of use of the Internet is a concern of people such as parents and teachers for the content which may be accessed. This is the flip side of the “open” nature of the Internet. This problem and some of the approaches to solving it are documented in the introductory section of PCT Patent Specification No. 97/15008 (AT&T). The approach described in the latter specification involves use of an administration relational database which determines access rights. URLs are assigned to particular access groups. It appears that this approach would be very useful for environments in which there are groups of users using machines in a network which accesses the administration database. Such an environment may, for example, be a classroom in a school. However, this approach does not appear to be feasible for home use by children or for use by adults who are travelling. An example of the latter situation is a commercial representative who needs to access electronic mail or a Web site as part of his or her daily work and whose employer wishes to confine his or her access to certain sites.

### OBJECTS OF THE INVENTION

It is therefore an object of the invention to provide a communication device and method which allows access to network content in a controlled manner, without the need to access an administration database for determining access rights.

Other objects of the invention are to provide a communication device and method which:

are easy to use by a wide range of people, and

provide attractive commercial opportunities for producers or suppliers of the device, so that the device may be marketed at a relatively low price.

### SUMMARY OF THE INVENTION

According to the invention, there is provided a communication apparatus comprising a processor connected to a memory, to a user interface, and to a communication interface, characterised in that,

the apparatus further comprises a card reader connected to the processor, and

the processor comprises means for accessing a network server only by initially reading user data setting user-specific controlled access conditions from a card inserted in the card reader.

In one embodiment, the processor comprises means for modifying displayed user options according to the user data.

In another embodiment, said modifying means comprises means for disabling a browser program display field for input of server addresses.

In a further embodiment, the processor accessing means comprises means for reading a proxy server address in the user data and for accessing the proxy server.

In another embodiment, the processor accessing means comprises means for accessing a proxy server providing a confined launch site for a communication session.

In one embodiment, the processor accessing means comprises means for accessing a proxy server providing a confined launch site and confined linked sites.

Preferably, the processor comprises means for updating a user-specific access list on a remote access server, and for reading from said list to determine allowed links for the proxy server.

In one embodiment, the processor comprises means for storing updated user data on the card according to a communication session.

Preferably, the processor comprises means for generating from the user data a temporary access file for a particular access session.

In another embodiment, the processor comprises means for generating a dialler configuration file including address data for a remote network server.

In one embodiment, the processor comprises means for generating a browser configuration file including browser display control parameters to control addressing inputs.

Preferably, the processor comprises means for encrypting user data stored on a card.

In another embodiment, said encryption means comprises means for prompting user input of a password and using a received password as an encryption key.

In one embodiment, the processor comprises means for reading a status flag on a card indicating if the card is being used for the first time.

In one embodiment, the processor comprises means for allowing user selection of a set of user data for a card storing a plurality of sets of user data.

Preferably, said selection means comprises a plurality of function keys, each associated with a set of user data.

In one embodiment, the function keys are coded by indicia on the keys corresponding to indicia marked on a card.

Preferably, the function keys are colour coded.

In one embodiment, the processor comprises means for operating without a fixed disk.

Preferably, the apparatus is portable.

In one embodiment, the user interface comprises a touch screen.

Preferably, the communication interface comprises a PCMCIA modem.

In another aspect, the invention provides a communication system comprising a communication device as defined above and a card storing user data setting controlled access conditions.

According to another aspect, the invention provides a machine-readable card storing user data setting controlled access conditions for user-specific network server access.

### DETAILED DESCRIPTION OF THE INVENTION

Brief Description of the Drawings

The invention will be more clearly understood from the following description of some embodiments thereof, given by way of example only with reference to the accompanying drawings in which:

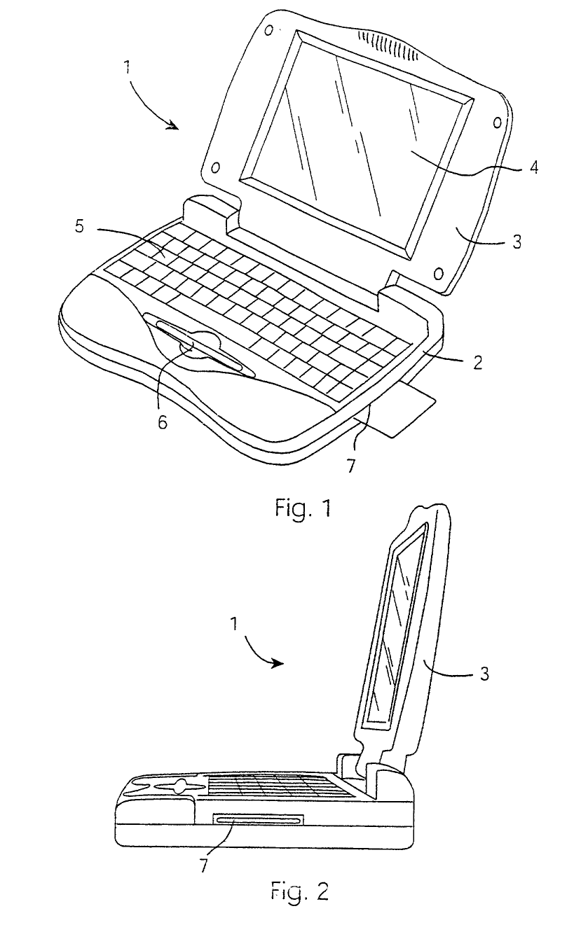

FIG. 1 is a perspective view from above of a communication device of the invention;

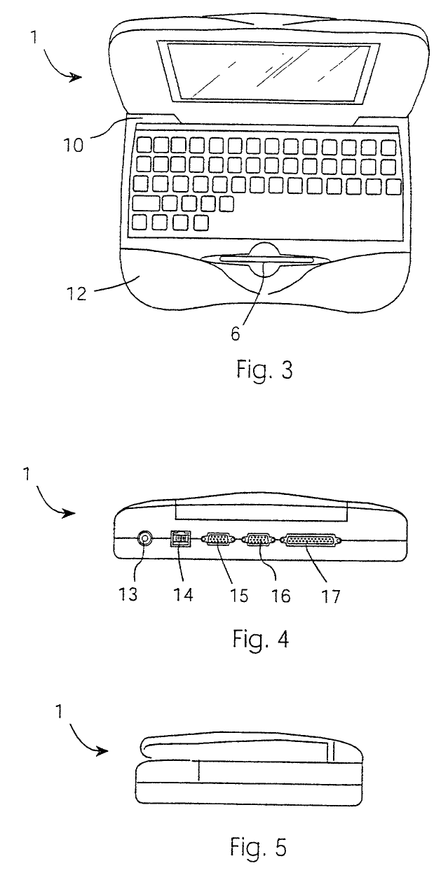

FIGS. 2, 3, 4, and 5 are side, plan, rear, and opposite side views of the device respectively;

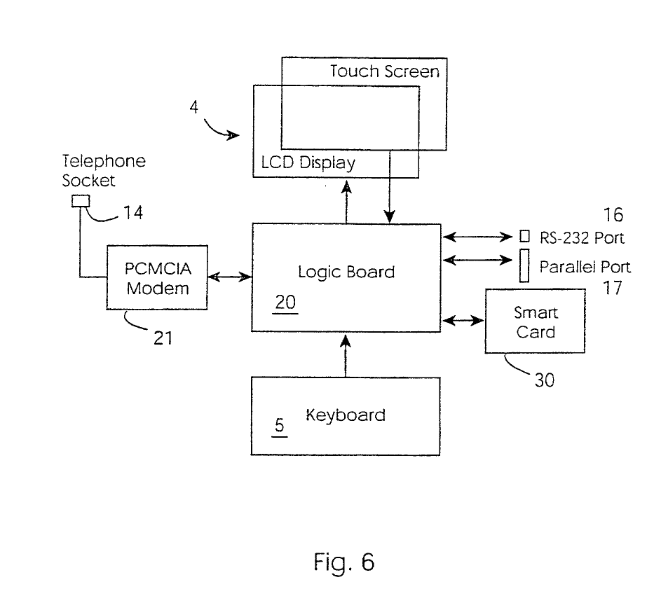

FIG. 6 is a block diagram of the hardware architecture;

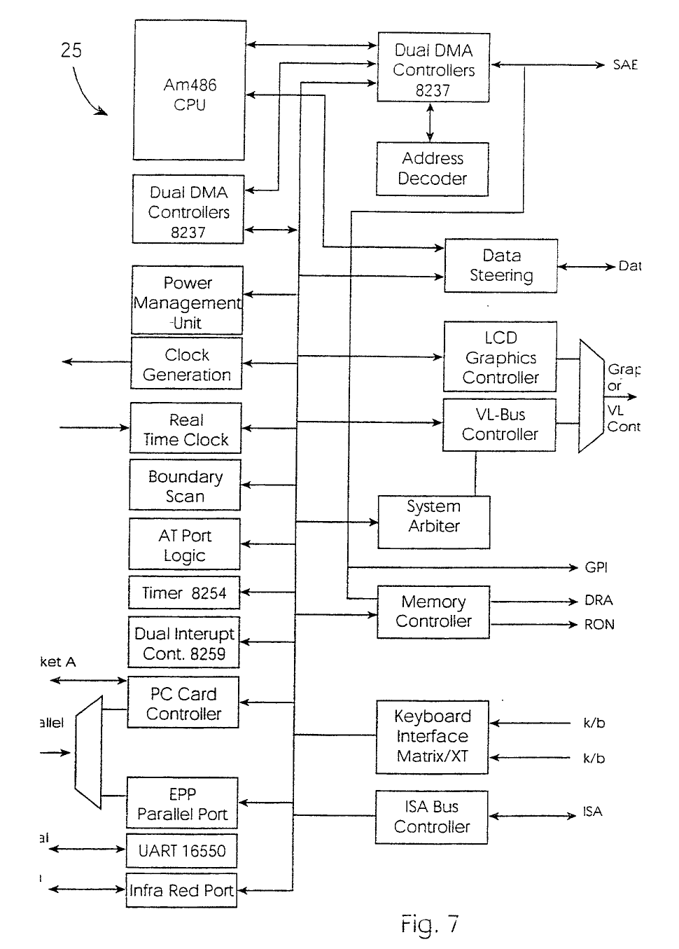

FIG. 7 is a block diagram of a microcontroller of the device;

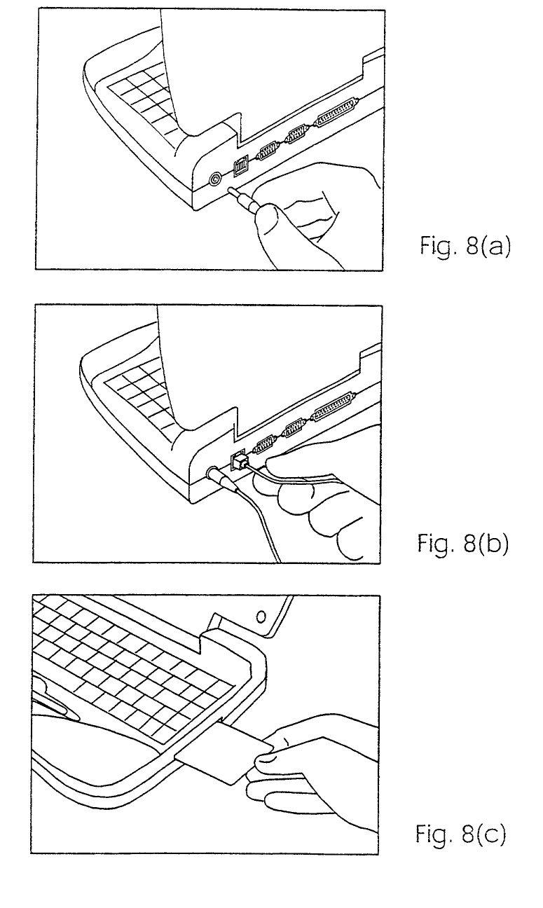

FIGS. 8(a), 8(b), and 8(c) are diagrammatic views illustrating installation and use of the device;

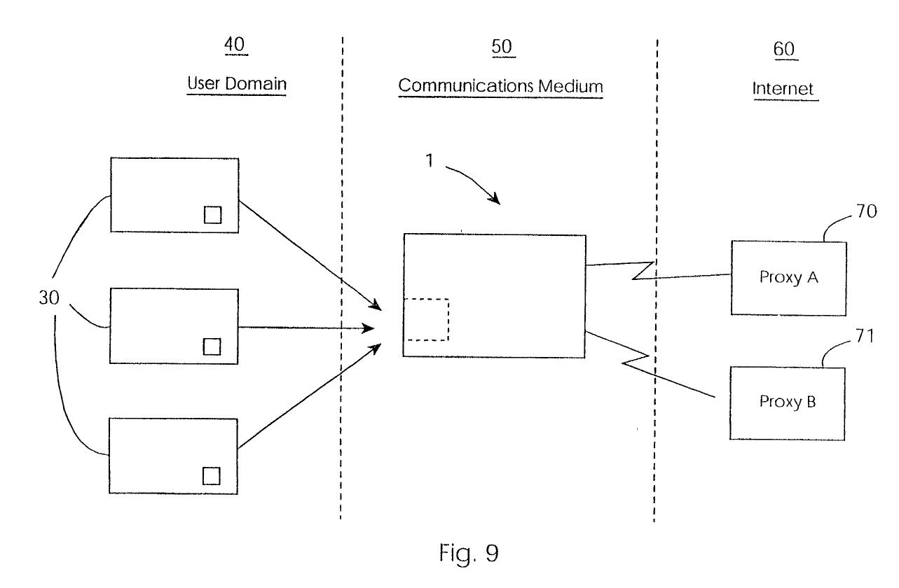

FIG. 9 is a diagram illustrating the overall context of a communication method; and

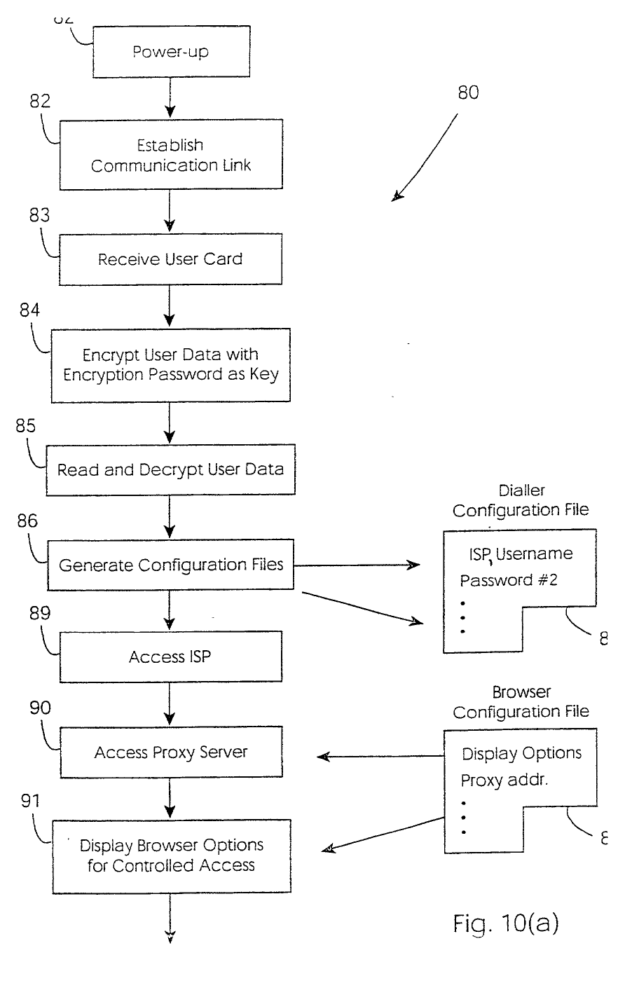

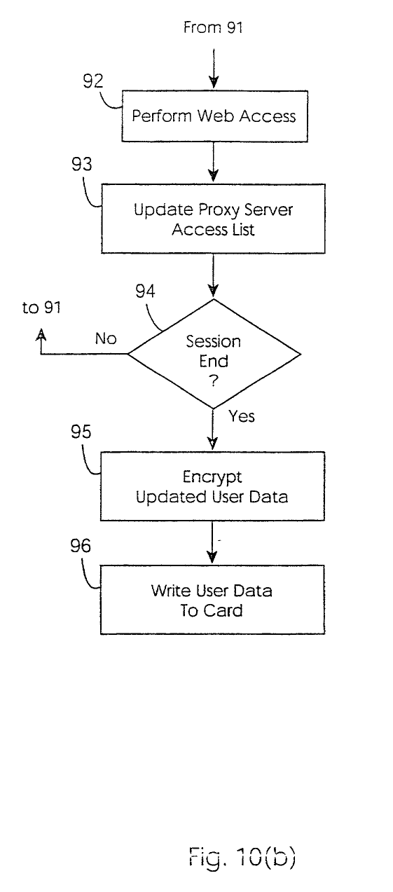

FIGS. 10(a) and 10(b) are together a flow diagram illustrating the method in more detail.

Referring to the drawings, and initially to FIGS. 1 to 5 there is shown a communication device 1. The device 1 is lightweight and is transportable. It has a clamshell configuration with a main body 2 which houses processing and communication circuits and an upper portion 3 with a display screen 4 of the touch-screen type. The main body comprises a keyboard 5 and a touch-screen pen 6. The main body also comprises a smart card reader 7, a built in speaker 10, and a moulded wrist rest 12. As shown in FIG. 4 there is a series of ports across the rear of the main body 2, namely a power port 13, a phone jack 14, an external monitor port 15, and external telephone jack 16, and a parallel printer port 17. The device 1 does not have a disk drive. The processor uses Flash memory storing the operating system. It is also programmed to transfer bulk data to an external storage device, either locally via the parallel port 14 or remotely via the modem jack 16. Typically, a remote storage device may be a server such as an Internet server.

The construction of the device 1 is very inexpensive, allowing it to be retailed at a fraction of the cost of a typical PC. The important features which allow this include the following:

Use of a processor which is less powerfull than the current typical PC processor.

Use of Flash memory.

Absence of a fixed disk drive.

Simple and compact physical configuration.

An important aspect of the device I is that the processor is programmed to automatically access a network server such as an Internet Service Provider. Also, the access is driven by data which is particular to the user. This user data confines access to one or a limited number of sites. To achieve this, the user data controls access to Uniform Resource Locators (URLs). Thus, a commercial organisation may supply smart cards to customers in a commercial arrangement whereby Internet access is controlled according to the user data on the card. For example, a telecommunications utility may supply to subscribers cards which allow access only to its Internet site. Such an arrangement may, for example, allow supply of the device 1 at a low cost. In such an arrangement, the supplier benefits commercially in the long term by increasing access to certain sites, while the subscriber obtains a communications device which is very simple to use and is inexpensive.

Referring to FIGS. 6 and 7, the device 1 is now described in more detail. As shown in FIG. 7, the device 1 comprises a logic board 20 connected to the keyboard 5 and the touch screen LCD display sub-system 4. A smart card 30 is shown inserted in the device 1 APCMCIA modem is connected to the logic 20 board. The logic board 20 includes an ELAN SC400™ microcontroller 25, which is illustrated in FIG. 8. This combines a thirty two-bit low voltage Am486CPU with a complete set of PC/AT compatible peripherals together with power management features which are required for battery operation if required. The microcontroller is packaged in a 292 PIN ball grid array (BGA).

The microcontroller 25 has the following characteristics:

8 Kbyte write back cache,

fully static design with System Management Mode for low power consumption,

Other features of the microcontroller 25 include the following.

Comprehensive power management unit with seven modes of operation to allow fine tuning of power requirements for maximum power conservation performance

Glueless burst mode ROM/FLASH interface which Interfaces directly to static memory such as make ROM, FLASH and SRAM with three ROM/FLASH chip selects.

Glueless DRAM controller with Extended Data Out (EDO) and Fast Page Mode (FPM) DRAMs supported, and it allow mixed DRAM types on a per bank basis to reduce system cost.

Standard PC/AT system logic including dual Programmable Interupt Controllers (PIC) dual DMA controllers, Programmable Interval Timer (PIT) and Real time Clock (RTC).

DOS, ROM-DOS, Windows and industry standard BIOS support.

Local bus and ISA bus and ISA bus interface

Bidirectional parallel port with EPP mode

16550 compatible UART

Infrared port for wireless communication

Keyboard interface

Dual PC Card (PCMCIA version 2.1) controller supporting 8 or 16 bit data bus compliant with Exchangeable Card.

Referring now to FIGS. 8 to 10 inclusive, operation of the device 1 is now described. FIGS. 8(a), 8(b), and 8(c) illustrate three simple steps for user Web access. In a first step shown in FIG. 8(a), a user connects a power connector in the socket 13. In a second step shown in FIG. 8(b) the user connects a telephone jack into the connector 14. In a third step shown in FIG. 8(c) the user inserts his or her personal smart card 30 and touches a browser or email icon as appropriate. The device 1 then accesses the Internet according to user data on the card 30.

Referring to FIG. 9, the device 1 facilitates communication in which there are essentially three domains namely:

a user domain 40,

a communication medium 50, and

the Internet 60

The user domain 40 is encoded in the smart cards 30. These store user data controlling access on a user-specific basis. The device 1 performs the communication by drawing user data from a card 30 inserted in the device 1. The device accesses one of two proxy servers 70 and 71 respectively.

Referring to FIGS. 10(a) and 10(b) a communication method 80 implemented by the device 1 and the proxy servers 70 and 71 is now described. In a step 81 the device 1 is powered-up as shown in FIG. 8(a). A telephone jack is connected in step 82, as shown in FIG. 8(b), to establish a physical communication link. A user card 30 is inserted in step 83, as shown in FIG. 8(c).

The device 1 then prompts the user to input a password or passphrase for encryption. This is used by the device 1 to encrypt pre-set user data, using the password as a key. The user data is pre-set in the card 30 by a supplier (which may or may not be the supplier of the device 1), and it governs the nature of access for the user.

The decision to prompt input of a password is triggered by a “00” value of a flag in the user data. This value indicates that it is a first-time use. The user data is supplied factory-encrypted with a password, and the prompt allows the user to change it.

In step 85, the device 1 reads the (encrypted) user data using the encryption password as a key. It uses this data to generate in step 86 two configuration files namely a browser configuration file 87 “/tmp/browser/config” and a dialler configuration file 88 “/tmp/dialler/config2.

The dialler configuration file 88 includes user-specific dialling data including:

ISP address,

user name,

user password,

DNS, and

telephone number of ISP.

The browser configuration file 87 includes a flag value set after the “00” flag has been over-written. A “01” value indicates that the user has “closed” access and a value “10” indicates that the user has “open” access. In addition, this file indicates a proxy server address. For a closed access user, the proxy server allows limited hypertext links to other, chosen, sites. For example, a proxy server may allow access to a children's animated film information site and its linked sites only. For an “open” access user, the proxy server also provides controlled access insofar as the initial or launch site is pre-set for the user. This may, for example, be a site maintained by the card issuer. However, the site allows links to other sites on an open basis.

Access to the ISP is indicated by the step 89, and to the relevant proxy server by the step 90. Step 91 involves display of browser options for controlled access. Steps 90 and 91 involve display of browser options for controlled access. These steps may be simultaneous from the user viewpoint. The browser configuration file 87 sets the parameters for browser options. A simple and important example is blanking out the option to input alternative site URLs for a “closed” access user such as a child.

Web site access operations are indicated by the step 92 and these are followed by step 93 of updating a server access list for the user. This is a “white” list maintained on the server of allowed sites for “open” access. It may alternatively be a “black” list of disallowed sites, possibly purchased from a supplier. This step introduces an added dimension to access control and utilises the processing and storage capacity of the server.

As indicated by a decision step 94, the Web access steps 92 and 93 are continued until the user indicates a desire to terminate the session. When this happens, in step 95 the device 1 automatically encrypts user data and in step 96 writes it to the card 30. The updated data includes user-specific favourite or “hotlist” sites as determined during the communication session. This data may also include “cookie” data for the user. The data may include transaction data if the access involved performing a transaction. An important aspect is that user-specific data is dynamically updated to the card on an on-going basis as the card is used. The updated user data is written to the card 30 in step 96.

In another embodiment, the controlled access also involves user depression of “quick access” keys on the keyboard. These may be some of the function keys of a conventional keyboard. The quick access keys may be symbol or colour-coded and a matching symbol or colour may be printed on the smart card or displayed in a default URL page shown on the screen. This allows a single physical card to be effectively multiple cards because selection of a key activates an associated set of user data.

The invention achieves user-specific controlled access to network content in a very simple and comprehensive manner. The controlled access user data is effectively carried around by the user so that it can be used at any desired location. Also, the user data is dynamically updated during use and is encrypted. This ensures safe, secure, and relevant controlled access at all times. The used data and flags achieve this level of control in a versatile manner with different levels of control provided on a user-by user basis. Thus, it provides controlled access either for school-children or adults, irrespective of location.

It will also be appreciated that the invention allows very simple and quick access to a communication network such as the Internet, even for users who are not “computer literate”. Also, because of the construction of the device, the cost is very low. This allows much more widespread access to communication networks and use of electronic commerce. The invention also allows control over the URLs accessed to enhance commercial potential for the card issuer and/or provide improved control for children.

Another important aspect of the invention is that it allows users to roam with only the smart card and to use it to connect to a communication network anywhere a suitable communication device is located. For example, a device may be provided in public buildings such as hotels or public transport stations, allowing users to connect to their email for a small fee.

The invention provides excellent network access security-something which is very important for electronic commerce such as on-line insurance underwriting. In the existing technologies, security is typically achieved by:

“logging-on” with a user name and password,

digital certificates which ensure connection to the correct site, and

secure socket layer (SSL) encryption system with public and private keys.

The present invention provides an additional layer, namely physical presence of the smart card and its encryption. It is expected that this fourth layer would be very effective at reducing fraud.

The invention is not limited to the embodiments described but may be varied in construction and detail. For example, it is envisaged that enhanced versions of the device may include video conferencing features, or may include a wireless modem for complete portability. It is also envisaged that a portable data carrier other than a smart card be used such as a magnetic card.

The device may be portable by having its own power supply- much like a mobile phone. In this case a network such as a GSM network may be used for communication. This would allow, for example, field personnel such as sales representatives or engineers to immediately report data via email or another appropriate mechanism.

The network access features provided by the smart card may be achieved without using a device such as that described, and may instead be achieved using a conventional computer hardware using a smart card reader and being programmed to access a network site only according to user data on a card presented to it. The network access method provides excellent security.

The invention is not limited to the embodiments described but may be varied in construction and detail.

1. A communication apparatus comprising a processor connected to a memory, to a user interface, and to a communication interface, characterised in that,
the apparatus further comprises a card reader connected to the processor, and
the processor comprises means for accessing a network server only by initially reading user data setting user-specific controlled access conditions from a card inserted in the card reader.

2. An apparatus as claimed in claim 1, wherein the processor comprises means for modifying displayed user options according to the user data.

3. An apparatus as claimed in claim 2, wherein said modifying means comprises means for disabling a browser program display field for input of server addresses.

4. An apparatus as claimed in any preceding claim, wherein the processor accessing means comprises means for reading a proxy server address in the user data and for accessing the proxy server.

5. An apparatus as claimed in claim 4, wherein the processor accessing means comprises means for accessing a closed proxy server providing a confined launch site for a communications session.

6. An apparatus as claimed in claims 4 or 5, wherein the processor accessing means comprises means for accessing an open proxy server providing a confined launch site and confined linked sites.

7. An apparatus as claimed in claim 6, wherein the processor comprises means for updating a user-specific access list on a remote access server, and for reading from said list to determine allowed links for the proxy server.

8. An apparatus as claimed in any preceding claim, wherein the processor comprises means for storing updated user data on the card according to a communication session

9. An apparatus as claimed in claim 8, wherein the processor comprises means for generating from the user data a temporary access file for a particular access session.

10. An apparatus as claimed in claim 9, wherein the processor comprises means for generating a dialler configuration file including address data for a remote network server.

11. An apparatus as claimed in claims 9 or 10, wherein the processor comprises means for generating a browser configuration file including browser display control parameters to control addressing inputs.

12. An apparatus as claimed in any preceding claim, wherein the processor comprises means for encrypting user data stored on a card.

13. An apparatus as claimed in claim 12, wherein said encryption means comprises means for prompting user input of a password and using a received password as an encryption key.

14. An apparatus as claimed in claims 12 or 13, wherein the processor comprises means for reading a status flag on a card indicating if the card is being used for the first time, and for prompting user input of a password if the card is being used for the first time.

15. An apparatus as claimed in any preceding claim, wherein the processor comprises means for allowing user selection of a set of user data for a card storing a plurality of sets of user data.

16. An apparatus as claimed in claim 15, wherein said selection means comprises a plurality of function keys, each associated with a set of user data.

17. An apparatus as claimed in claim 16, wherein the function keys are coded by indicia on the keys corresponding to indicia marked on a card.

18. An apparatus as claimed in claim 17, wherein the function keys are colour coded.

19. An apparatus as claimed in any preceding claim, wherein the processor comprises means for operating without a fixed disk.

20. An apparatus as claimed in any preceding claim, wherein the apparatus is portable.

21. An apparatus as claimed in any preceding claim, wherein the user interface comprises a touch screen.

22. An apparatus as claimed in any preceding claim, wherein the communication interface comprises a PCMCIA modem.

23. A communication apparatus substantially as described with reference to the accompanying drawings

24. A communication system comprising a communication apparatus as claimed in any preceding claim and a card storing user data setting controlled access conditions.

25. A machine-readable card storing user data setting controlled access conditions for user-specific network server access.
